(19) United States
(12) Patent Application Publication
(10) Pub. No.: US 2022/0163373 A1
(43) Pub. Date: May 26, 2022

(54) MEASUREMENT SYSTEMS AND METHODS

(71) Applicant: Bruce Wooten, Huntsville, AL (US)

(72) Inventor: Bruce Wooten, Huntsville, AL (US)

(21) Appl. No.: 17/103,340

(22) Filed: Nov. 24, 2020

(51) Int. Cl. G01G 21/23; G01L 1/22; G01G 23/42; F24F 11/52

(52) U.S. Cl. CPC G01G 21/23; F24F 11/52; G01G 23/42; G01L 1/2287

(57) ABSTRACT

A measurement system of the present disclosure has a container configured for holding a tank filled with a substance and configured for determining an initial weight of the substance and a subsequent weight of the substance after use. Further, the measurement system has a handheld device communicatively coupled to the container and a processor configured for determining a differential in weight between the initial weight and the subsequent weight and transmit the differential to the handheld device.

### BACKGROUND

In the heating ventilation and air conditioning (HVAC) trade, companies, and individuals (workers) visit people's homes to help them with their heating and cooling systems that may not be operating properly. Oftentimes, a person's air conditioning, is low in freon contained in the air condition unit.

When your air condition unit is low on freon, the evaporator coil gets too cold and causes the cold liquid refrigerant to flow back through the refrigerant line. This causes the surrounding moisture on the refrigerant line to freeze up. This is a sign you need freon.

Freon is a non-combustible gas that is used as a refrigerant in the air condition unit. This freon undergoes an evaporation process over and over to help produce cool air that can be circulated throughout your air condition unit.

When a worker visits the person's home, he/she first determines the problem with the air condition unit. If the problem is that the air condition unit is low on freon, the worker replenishes the air conditioning with freon.

This task comprises removing a tank full of freon from a vehicle. The worker replenishes the air condition unit with freon. He/she manually determines how much freon was used in the replenishment and records the amount of freon was used in the replenishment.

Oftentimes, there is no employee or customer transparency to the amount of refrigerant that is used in the customer's air conditioning. That is, the employee merely guesses at the amount that was used, and this guesstimate is reflected in the bill that is provided to the customer.

Considering the foregoing, sometimes refrigerant goes unaccounted for. Further, refrigerant may be stolen from the tank. Thus, there is no accounting for all the refrigerant that is used from a tank.

### DESCRIPTION OF DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is an exemplary measurement system in accordance with an embodiment of the present disclosure.

FIG. 2A is an exemplary container for holding freon for the measurement system of FIG. 1.

FIG. 2B is an exemplary box for storing the container for holding freon as shown in FIG. 2A.

FIG. 2C is an exemplary box shown in FIG. 2B for storing the container for holding freon as shown in FIG. 2A.

FIG. 3 is the exemplary box shown in FIG. 2B further comprising a controller.

FIG. 4 is the exemplary box shown in FIG. 3 further comprising a weight pad in accordance with an embodiment of the present disclosure communicatively coupled to the controller.

FIG. 5 is the exemplary box comprising one or more force sensitive resistors coupled to the controller.

FIG. 6 is a block diagram of a controller in accordance with an embodiment of the present disclosure.

FIG. 7 is a flowchart of exemplary architecture and functionality of the system of the present disclosure as shown in FIG. 1.

FIG. 8 is a perspective view of an exemplary rack in which an exemplary container is placed in accordance with an embodiment of the present disclosure.

FIG. 9 is a perspective view of an exemplary container in a tank weighing instrument in accordance with an embodiment of the present disclosure.

### DETAILED DESCRIPTION

The present disclosure describes a system for measuring and tracking a substance, e.g., freon. The substance is contained in a tank, which is often store in a box. The box comprises a controller and one or more weight detection devices. While the tank is in the box, the controller records the amount of substance in the tank via weight detection devices. Once substance has been removed from the tank, the tank is placed back into the box. The controller then records the new weight of the substance in the tank thereby obtaining a differential between before the tank was used and after the tank was used. The controller transmits data indicative of the differential to a handheld device, e.g., a smart phone or a tablet. The handheld device associates the differential with a client, which also determines the amount of money owed for the substance. In one embodiment, this information may be sent over a network to an accounting system that tracks customers and the amount freon used for determining how much money the customer owes for the substance.

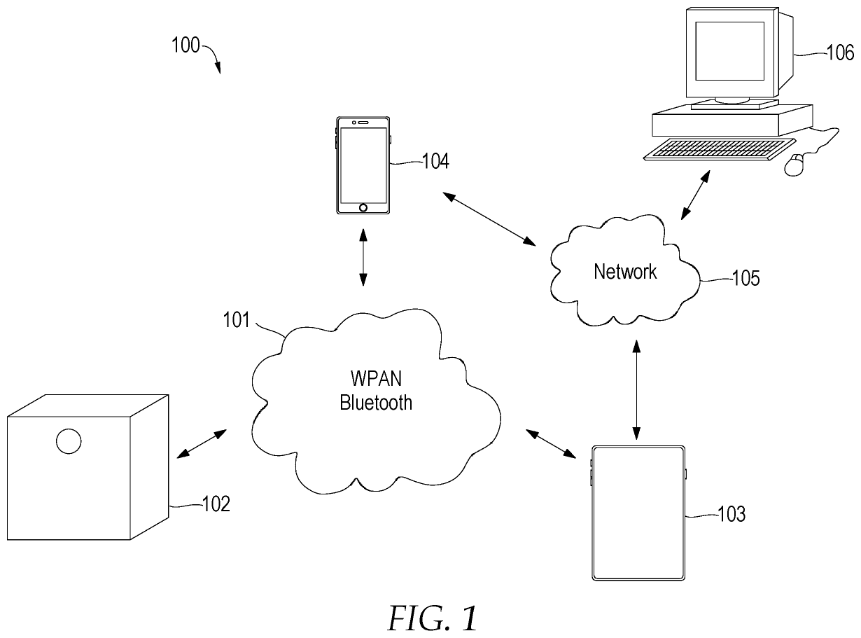

FIG. 1 is a measurement system 100 in accordance with an embodiment of the present disclosure. The system comprises a tank weighing instrument 102 that is configured to communicate with a handheld device, e.g., the smartphone 104 or the tablet 103 via a wireless personal area network (WPAN). Further, communication with the tank weighing instrument 102 may use Bluetooth™, which is another WPAN standard that operates in the 2.4 GHz range using a method called frequency-hopping spread spectrum. That is, the handheld device would communicate with the tank weighing instrument via Bluetooth™.

The handheld device, e.g., the smartphone 104 or the tablet 103, is communicatively coupled to a central computing device 106 via a network 105, which can be the Internet.

In operation, a tank (not shown) is contained within the box 102. While in the tank weighing instrument 102, the tank weighing instrument 102 measures the initial amount of substance in the tank. The tank is removed from the tank weighing instrument 102, and some of the substance within the tank is used thereby reducing the amount of substance in the tank and reducing the weight of the tank. The tank is placed back in the tank weighing instrument 102. The tank weighing instrument 102 measures a new amount of substance in the tank, which is less than the initial amount.

The tank weighing instrument 102 transmits the differential amount between the initial amount and the new amount to a handheld device, e.g., the smartphone 104 and/or the tablet 103. In one embodiment, the handheld device associates the differential amount with a customer. In such an embodiment, a user may enter customer information associated with the differential amount.

In one embodiment, the user may bill the customer on-site. That is, the customer pays for the differential amount on-site.

In another embodiment, the handheld device transmits the customer information and the differential amount to the computing device 106 via the network 106. The computing device 106 may be running a billing software. In such a scenario, the computing device 106 via the billing software may generate an invoice for the customer, which is transmitted to the customer for payment.

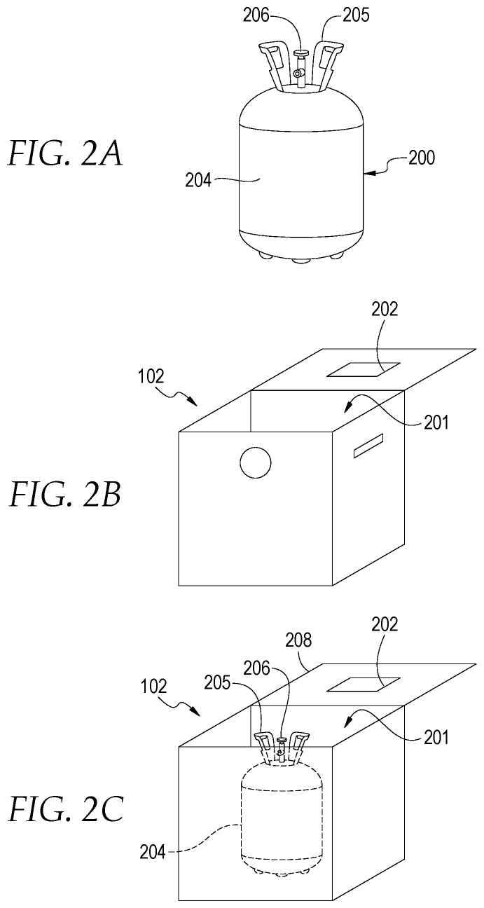

FIG. 2A is an exemplary tank 200 for use in the system 100 (FIG. 1). The tank 200 comprises a receptacle 204 for holding the substance, e.g., freon. At the top of the tank 200 are handles 205 for picking up and moving the tank. Further, at the top of the tank 200 is a valve 206 for delivering substance, e.g., freon, to an air condition unit.

FIG. 2B is a tank weighing instrument 102. The tank weighing instrument 102 comprises a vessel 201 for holding the tank 200 (FIG. 2A). The handles 205 (FIG. 2) and the valve 206 (FIG. 2A) are exposed via an opening 202 in the tank weighing instrument 102.

FIG. 2C shows the tank 200 contained within a cavity 201 of the tank weighing instrument 102 When a lid 208 is closed, the handles 205 and the valve 206 are exposed for easy access.

Note that the tank weighing instrument is a box; however, the tank weighing instrument may take different forms in other embodiments, which are described herein.

Further note that the tank weighing instrument 102 may operate in a standalone mode. In such a mode, the tank weighing instrument 102 comprises a small light emitting diode (LED) screen that displays initial weights, weights measured after refrigerant is delivered, and the differential thereof.

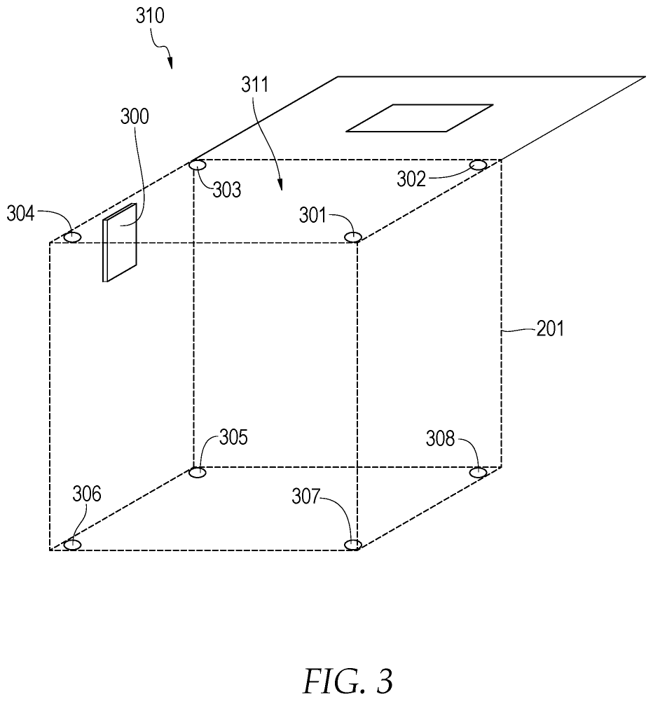

FIG. 3 is an exemplary embodiment of a tank weighing instrument 310 in accordance with an embodiment of the present disclosure. Note that it is shaped as a box; however, it can be different shapes in different embodiments.

The tank weighing instrument 310 comprises a vessel 311. Contained within the vessel 311 is a plurality of force sensing resistors in each corner of the vessel 311, including force sensing resistors 301-308. The force sensing resistors 301-308 are communicatively coupled to the controller 300. When the tank (not shown) is in the vessel 311 the force applied to the force sensing resistors 305-308 decrease the resistance in the force sensing resistors 305-308, which is transmitted to the controller. The controller translates this decrease in resistance to an initial weight. The tank is then removed, and a portion of the substance contained in the tank is removed.

In operation, the tank is placed back within the vessel 311. When the tank is placed within the vessel 311 the force applied to the force sensing resistors 305-308 decreases the resistance in the force sensing resistors 301-308, and the controller translates the decrease in resistance to force or weight to obtain a new weight signifying the amount of substance used for the customer.

The differential between the initial weight and the new weight is transmitted to the handheld device, e.g., the smartphone or the table. On the handheld device, the user can associate the differential with a customer. Further, the handheld device can transmit the customer data and the weight data to the computing device 106 for use in billing software.

Note that the tank weighing instrument 310 also has force sensing resistors 301-304. In this regard, the user need not remove the tank from the tank weighing instrument 310. Instead, the user can turn the tank weighing instrument 310 upside down to deliver the substance, e.g., freon, to the air condition unit. The decrease in resistance of the force sensing resistors 301-304 is communicated to the controller 300, which translates the decrease in resistance to a change of weight thereby signifying the amount of substance used for the customer.

Note that eight force sensing resistors 301-308 are shown in FIG. 3. However, more, or fewer force sensing resistors 301-308 may be used in other embodiments.

Further note that the tank weighing instrument 310 may operate in a standalone mode. In such a mode, the tank weighing instrument 310 comprises a small light emitting diode (LED) screen that displays initial weights, weights measured after refrigerant is delivered, and the differential thereof.

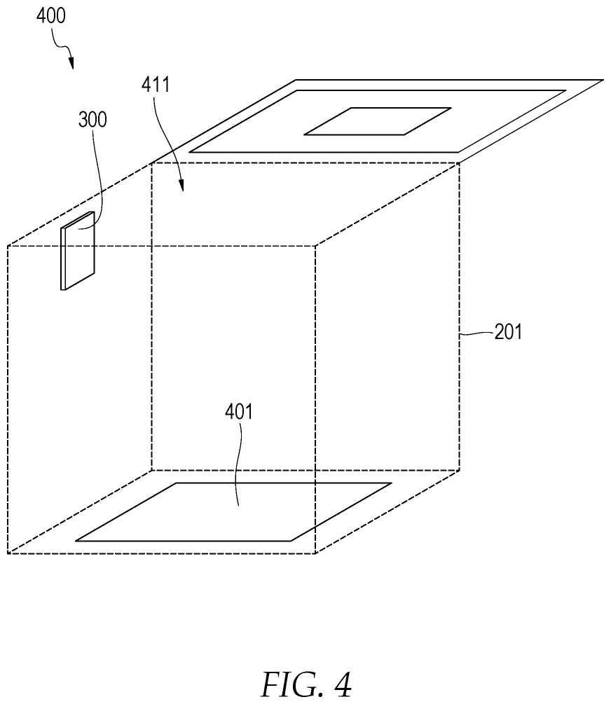

FIG. 4 is an exemplary embodiment of a tank weighing instrument 400 in accordance with an embodiment of the present disclosure. The tank weighing instrument 400 comprises a vessel 411. Contained within the vessel 411 is a weight mat 401. The weight mat 401 is communicatively coupled to the controller 300. When the tank (not shown) is in the vessel 411 a force is applied to the weight mat 401, which is transmitted to the controller. The tank is removed from the box 411 and a portion of the substance, e.g., freon, contained in the tank is removed.

In operation, the tank is placed back within the vessel 411. When the tank is placed within the vessel 411, the weight applied to the weight mat 401 decreases, and the controller 300 translates the data received to obtain a new weight signifying the amount of substance used for the customer.

The differential between the initial weight and the new weight is transmitted to the handheld device, e.g., the smartphone or the table. On the handheld device, the user can associate the differential with a customer. Further, the handheld device can transmit the customer data and the weight data to the computing device 106 (FIG. 1) for use in billing software.

Further note that the tank weighing instrument 400 may operate in a standalone mode. In such a mode, the tank weighing instrument 400 comprises a small light emitting diode (LED) screen that displays initial weights, weights measured after refrigerant is delivered, and the differential thereof.

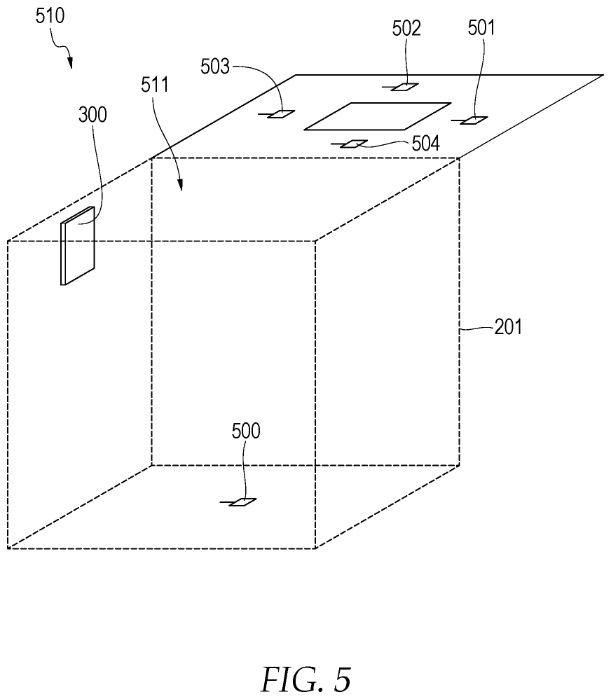

FIG. 5 is an exemplary embodiment of a tank weighing instrument 510 in accordance with an embodiment of the present disclosure. The tank weighing instrument 510 comprises a vessel 511. Contained within the vessel 511 is a weigh cell 500. The weigh cell 500 is communicatively coupled to the controller 300. When the tank (not shown) is in the vessel 511 a force is applied to the weigh cell 500, which is transmitted to the controller. The controller translates this information to an initial weight. The tank is removed from the vessel 511 and a portion of the substance, e.g., freon, contained in the tank is removed.

In operation, the tank is placed back within the vessel 511. When the tank is placed within the vessel 511 a force is applied to the weigh cell 500, and the controller translates the force to obtain a new weight signifying the amount of substance used for the customer.

The differential between the initial weight and the new weight is transmitted to the handheld device, e.g., the smartphone or the table. On the handheld device, the user can associate the differential with a customer. Further, the handheld device can transmit the customer data and the weight data to the computing device 106 (FIG. 1) for use in billing software.

Further note that the tank weighing instrument 510 may operate in a standalone mode. In such a mode, the tank weighing instrument 510 comprises a small light emitting diode (LED) screen that displays initial weights, weights measured after refrigerant is delivered, and the differential thereof.

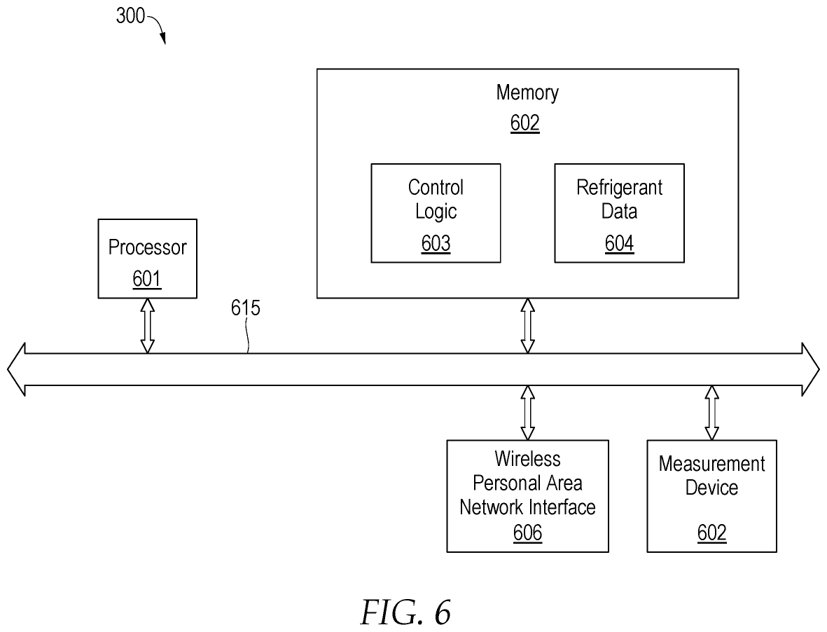

FIG. 6 is an exemplary controller 300 in accordance with an embodiment of the present disclosure. The controller 300 comprises a processor 601, memory 602, and a wireless personal area network interface 606. Stored in memory 602 is control logic 603 and refrigerant data 605.

The controller 300 generally controls the functionality and operations of the box 102, as will be described in more detail hereafter. It should be noted that the control logic 603 can be implemented in software, hardware, firmware, or any combination thereof. In an exemplary embodiment illustrated in FIG. 6, the control logic 603 is implemented in software and stored in memory 602.

Note that the control logic 602, when implemented in software, can be stored, and transported on any computer-readable medium for use by or in connection with an instruction execution apparatus that can fetch and execute instructions. In the context of this document, a “computer-readable medium” can be any means that can contain or store a computer program for use by or in connection with an instruction execution apparatus.

The exemplary embodiment of the controller 300 depicted by FIG. 6 comprises at least one conventional processing element 601, such as a digital signal processor (DSP) or a central processing unit (CPU), which communicates to and drives the other elements within the controller 300 via a local interface 615, which can include at least one bus. Further, the processing element 4001 is configured to execute instructions of software, such as the control logic 4000.

In operation, measurement data is provided to the controller 300 via a measurement device interface 607. The control logic stores the data as refrigerant data 604. Further, the control logic translates the data received from the measurement device into data indicative of weight. Once substance from the tank is used, the control logic 603 receives another reading from the measurement device 607. The control logic 603 determines a differential in weight.

The controller 300 transmits this weight differential to a handheld device via the wireless personal area network interface 606.

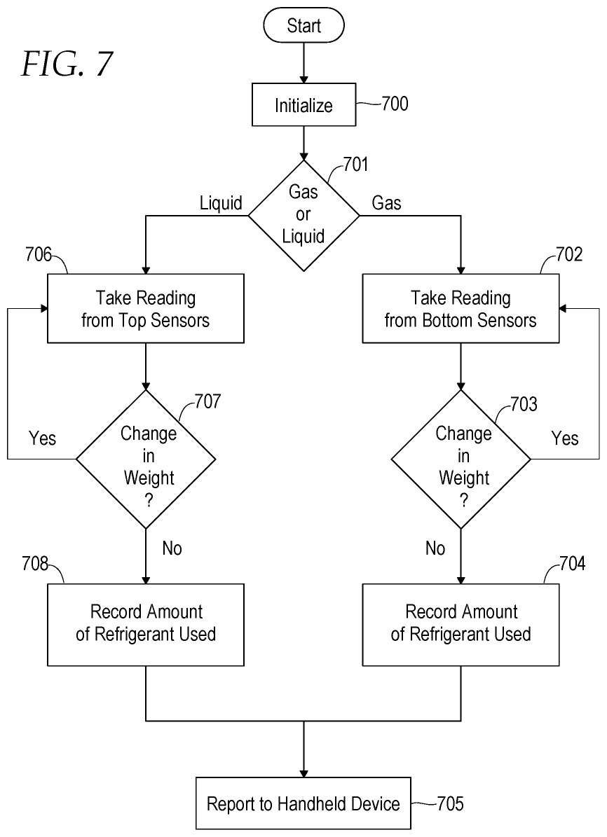

FIG. 7 is a flowchart of exemplary functionality and architecture of the system 100 (FIG. 1). Note that a refrigerant is both a liquid and a gas.

In step 700, the system initializes, which can include obtaining an initial weight in the tank of a gas or a liquid. In step 701, the user determines if the tank contains gas or liquid.

If the tank contains liquid in step 701, the user flips the tank upside down, a reading is taken from top sensors. Typically, if the tank contains gas, a reading is taken from the bottom sensors.

A reading is taken from the top sensors in step 706. If there is change in weight in step 707 refrigerant has been used. there is a change in weight, the system records the amount of refrigerant used in step 708 and reports to the handheld device 705.

A reading is taken from the bottom sensors in step 702. If there is a change in weight in step 703, the system records the change in weight of the substance used in step 704 and reports it to the handheld device in step 705.

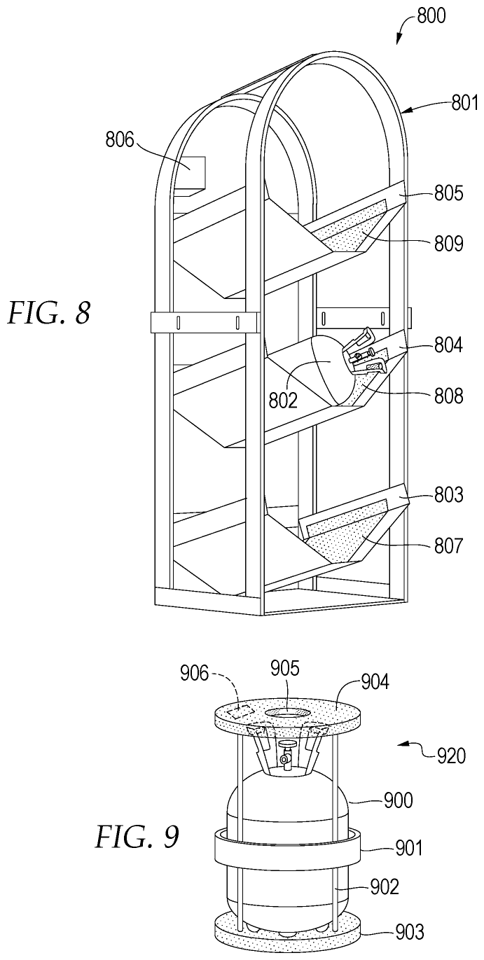

FIG. 8 is a tank weighing instrument 800 in accordance with an embodiment of the present disclosure. The tank weighing instrument 800 comprises a frame 801 for holding tanks of substances, e.g., freon. In this regard, tank 802 is shown laying on a trough 804 of the frame 801. Note that at any given time, there may be one to two three tanks on troughs 803-805 of the frame 801. For simplicity, only one tank 802 is shown laying on trough 804 of the frame 801.

Coupled to the frame is a controller 806. The controller is any type of computing device capable of receiving data, performing calculations on the data, and transmitting data to a central computing device. In this regard, the controller comprises a processing element (not shown), memory (not shown), and software (not shown) in the memory for performing the receiving, calculating, and transmitting.

Coupled to each trough 803-805 are weight mats 807-809. A weight mat 807-809 transmits an output signal indicative of weight placed upon the weight mats 807-809.

The controller 806 receives data indicative of the weight on the mats 807-809. The controller 806 calculates the weight of the substance in the tank in the trough based on the data indicative of weight received. This is an initial weight.

A user takes a tank 802 from the trough 804 and uses the tank to put a substance, e.g., freon, in an air conditioning unit. Thus, the amount of substance in the tank decreases.

The user places the tank 802 back onto the trough 804, and the weight mat 808 detects data indicative of a new weight. The mat 808 transmits the data indicative of the new weight to the controller 806. The controller 806 then calculates a change in weight of the substance in the tank, which is indicative of the substance used for a customer.

The differential between the initial weight of the substance and the new weight of the substance is transmitted to the handheld device, e.g., the smartphone or the table. On the handheld device, the user can associate the differential with a customer. Further, the handheld device can transmit the customer data and the weight data to the computing device 106 (FIG. 1) for use in billing software.

In one embodiment, each of the troughs can be labeled, e.g., 1, 2, and 3. Further, each of the tanks going on the troughs could be labeled, e.g., 1, 2, 3. Thus, the controller 300 recognizes for trough 1, tank 1 has been placed, and so on.

In another embodiment, each tank may comprise a radio frequency identification (RFID) tag with a foam spacer. The RFID tag may be placed on the side of the tank or on the bottom of the tank. Strategically placed RFID scanners or readers may be mounted on the. For example, an RFID reader may be mounted on a side of the frame or on a back of a trough.

In such an embodiment, a programmable logic controller (PLC) may receive the data indicative of pressure from the pressure mat 807-809. Further, the PLC may receive an RFID from the scanner or reader. The PLC transmits the data indicative of pressure and the RFID to the controller. Thus, the controller 300 can track the amount of substance used by a particular identified tank.

Further note that the tank weighing instrument 800 may operate in a standalone mode. In such a mode, the tank weighing instrument 800 comprises a small light emitting diode (LED) screen that displays initial weights, weights measured after refrigerant is delivered, and the differential thereof.

FIG. 9 is a tank weighing instrument 920 in accordance with an embodiment of the present disclosure. The tank weighing instrument 920 comprises a belt 901 that encircles the circumference of a tank 900.

The tank weighing instrument 920 comprises a top support 904 and a bottom support 903. To stabilize the tank weighing instrument 920, there are a plurality of bars 902 that coupled to the bottom support 903, to the belt 901, and to the top support 904.

Note that the top support 904 and the bottom support 903 may be any type of material in which weight sensors (not shown) and a controller 906 could be embedded. For example, the top support 904 and the bottom support 903 may be comprised of a stiff foam-like material.

In operation, weight sensors (not shown) in the bottom support 903 obtain an initial weight of the tank 900 and report said initial weight to the controller 906. A user may lift the tank weighing instrument 920, turn it over, and supply a substance, e.g., freon, to an appliance, e.g., an air conditioner. In such a scenario, there are sensors (not shown) in the top support 904 that report data indicative of weight to the controller 906 as substance is leaving the tank. Thus, the controller 906 determines a weight differential indicative of how much substance is used.

Further note that the tank weighing instrument 920 may operate in a standalone mode. In such a mode, the tank weighing instrument 920 comprises a small light emitting diode (LED) screen that displays initial weights, weights measured after refrigerant is delivered, and the differential thereof.

1. A measurement system, comprising
a container configured for holding a tank filled with a substance and configured for determining an initial weight of the substance and a subsequent weight of the substance after use;
a handheld device communicatively coupled to the container; and
a processor configured for determining a differential in weight between the initial weight and the subsequent weight and transmit the differential to the handheld device.

2. The measurement system of claim 1, wherein the handheld device is communicatively coupled to a computing device.

3. The measurement system of claim 2, wherein the computing device is configured to associate the differential with a customer.

4. The measurement system of claim 3, wherein the computing device is configured to bill the customer for the differential.

5. The measurement system of claim 1, wherein the handheld device is configured to associate the differential with a customer.

6. The measurement system of claim 5, wherein the handheld device is configured to bill the customer for the differential.

7. The measurement system of claim 1, wherein the container comprises one or more force sensing resistors on a bottom of the container.

8. The measurement system of claim 7, wherein when a tank is placed on the force sensing resistors, a decrease in resistance in transmitted.

9. The measurement system of claim 8, wherein the processor is configured to translate the decrease in resistance to a weight.

10. The measurement system of claim 9, wherein the processor is configured to translate a decrease in resistance to a subsequent weight.

11. The measurement system of claim 7, wherein the container comprises one or more force sensing resistors on a top of the container.

12. The measurement system of claim 11, wherein when a tank is placed in the container and turned upside down, the force sensing resistors have a decrease in resistance, which is transmitted.

13. The measurement system of claim 12, wherein the processor is configured to translate the decrease in resistance to a weight.

14. The measurement system of claim 13, wherein the processor is configured to translate a decrease in resistance to a subsequent weight.

15. The measurement system of claim 1, further comprising a pressure mat on a bottom floor of the container.

16. The measurement system of claim 15, when a tank is placed within the container a pressure is transmitted.

17. The measurement system of claim 16, wherein the processor is configured to translate the pressure to a weight.

18. The measurement system of claim 17, wherein when the tank is placed back into the container after substance has been used, the pressure transmits a subsequent pressure.

19. The measurement system of claim 1, wherein the container comprises at least one weigh cell.

20. The measurement system of claim 19, wherein when the tank is placed inside the container, the weigh cell transmits an initial weight.

21. The measurement system of claim 20, wherein when the tank is placed back inside the container, the weigh cell transmits a subsequent weight.
